(19) United States
(12) Patent Application Publication
(10) Pub. No.: US 2010/0288228 A1
(43) Pub. Date: Nov. 18, 2010

(54) INTERNAL COMBUSTION ENGINE HAVING AN INTAKE SYSTEM

(75) Inventors: Andreas Puschnik, Leutschach (AT); Josef Mlinar, Stainz (AT)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: AVL LIST GMBH

(21) Appl. No.: 12/734,222

(22) PCT Filed: Sep. 22, 2008
(86) PCT No.: PCT/EP2008/062633

§ 371 Date: May 17, 2010

(30) Foreign Application Priority Data
Oct. 18, 2007 (AT) A 1676/2007

(51) Int. Cl. F02B 31/00; F02M 25/07

(52) U.S. Cl. 123/306; 123/568.11

(57) ABSTRACT

The invention relates to an internal combustion engine (1), comprising an intake system (2) and an exhaust system, with the exhaust system being connected to the intake system (2) via at least one exhaust gas recirculation line (3) ending in an intake line (4), and with at least one swirl element (8) being disposed within the intake line (4). In order to achieve good thorough mixing of the recirculated exhaust gas with fresh air, it is provided that the swirl element (8) is arranged in the region of the wall (4a) of the intake line (4).

The invention relates to an internal combustion engine, comprising an intake system and'an exhaust system, with the exhaust system being connected to the intake system via at least one exhaust gas recirculation line ending in an intake line, and with at least one swirl element being disposed within the intake line.

In exhaust gas recirculation, the cooled exhaust gas allows the combustion temperature to decrease in the homogeneous mixture with fresh air. The percentage of nitrogen oxides in the exhaust gas will thus decrease. Optimal reduction of nitrogen oxides can only be realized in internal combustion engines with multiple cylinders however when the recirculated exhaust gas quantities are distributed evenly among all cylinders. In order to achieve this goal, good mixture of the fresh air with the recirculated exhaust gas is necessary.

DE 100 07 243 C1 describes an exhaust gas recirculation apparatus with an admixing device. The exhaust gas recirculation line opens into a fresh-air line via an exhaust opening or an admixing opening, with a swirl-generating element and/or a turbulence-generating element being provided in the region of the admixing opening. The achieved mixing results are not always sufficient, however. It is a further disadvantage that the particle count is increased by the admixing device and the flow resistance in the fresh-air line is influenced disadvantageously.

An exhaust gas recirculation system for an internal combustion engine is known from JP 2000-161148 A and JP 2004-232617 A, with the exhaust gas recirculation line opening tangentially into an intake line via two orifices. This leads to a swirling inflow of the recirculated exhaust gas. The disadvantageous aspect is however that the result of the thorough mixture depends strongly on the flow speed of the recirculated exhaust gas, with the share of turbulence being too low in the case of low inflow speeds of the exhaust gas in order to achieve a thorough mixture with the core zone of the fresh air because the exhaust gas rests predominantly on the surfaces of the fresh-air line.

Examinations have shown that as a result of the higher exhaust gas temperature and the lower density the recirculated exhaust gas will accumulate as a result of centrifugal forces in the region of the inside radius of an intake manifold in a smooth intake line. This leads to an adverse mixture of the charge air with the exhaust gas. As a result of this adverse mixture, there is also no even distribution of the exhaust gas to the individual cylinders in the case of multi-cylinder internal combustion engines.

It is the object of the invention to avoid such disadvantages and to achieve a thorough mixture of the recirculated exhaust gas with fresh air in the simplest possible way.

This is achieved in accordance with the invention in such a way that the swirl element is disposed in the region of the wall of the intake line. Since the swirl element is arranged in the region of the wall of the intake line, the thorough mixing of the recirculated exhaust gas with the core zone of the fresh air can be improved considerably.

In order to achieve an especially thorough mixture, it is especially advantageous when the swirl element is preferably arranged as a multi-thread screw surface, ideally with at least one separate opening of an exhaust gas recirculation line for each screw thread, with the openings being spaced from one another in the circumferential direction and/or direction of flow. Short guide ribs which are arranged in a simple geometrical way already show sufficient thorough mixing in combination with still low pressure losses. Moreover, these simple guide ribs offer the possibility of optimizing the pressure losses by local variation of the helix angle in the case of a non-circular cross section of the intake line. The thorough mixing of the exhaust gas with the fresh air occurs in a preferably straight mixing section of the intake line. In the case of a simple or multiple curved mixing section, curvatures and bends in the progress of the mixing section can be compensated by swirl elements which are adjusted locally with respect to helix angle and/or height. This ensures that the mixing section can be kept very short. The mixing section can be followed by an intake manifold which is flowed through by a homogeneously mixed exhaust gas/fresh air mixture.

The swirl element is advantageously formed by a guide rib. Several mutually axially spaced swirl elements can preferably be arranged in the intake line.

The exhaust gas recirculation line opens transversally, preferably at a right angle, into the intake line. An especially good through mixture of the recirculated exhaust gas with the fresh air at minimum pressure loss is achieved when the swirl element is arranged downstream of the opening of the exhaust gas recirculation line into the intake line. In the case of a spatially curved intake line, an exhaust gas recirculation line which is inclined up to 60° transversally to the axis of the intake line can counteract demixing tendencies caused by differences in density between the components of fresh air and exhaust gas under the action of centrifugal forces especially in the region of the opening of the exhaust gas recirculation line. Further potential for improvement in curved intake lines is provided by a lateral offset of the opening of the exhaust gas recirculation line from the central plane by up to 30% of the hydraulic diameter of the intake line or a combination with lateral inclination.

In order to keep the number of individual parts as small as possible, the swirl element can be arranged in an integral way with the intake line.

The invention is now explained in closer detail by reference to the drawings which show schematically:

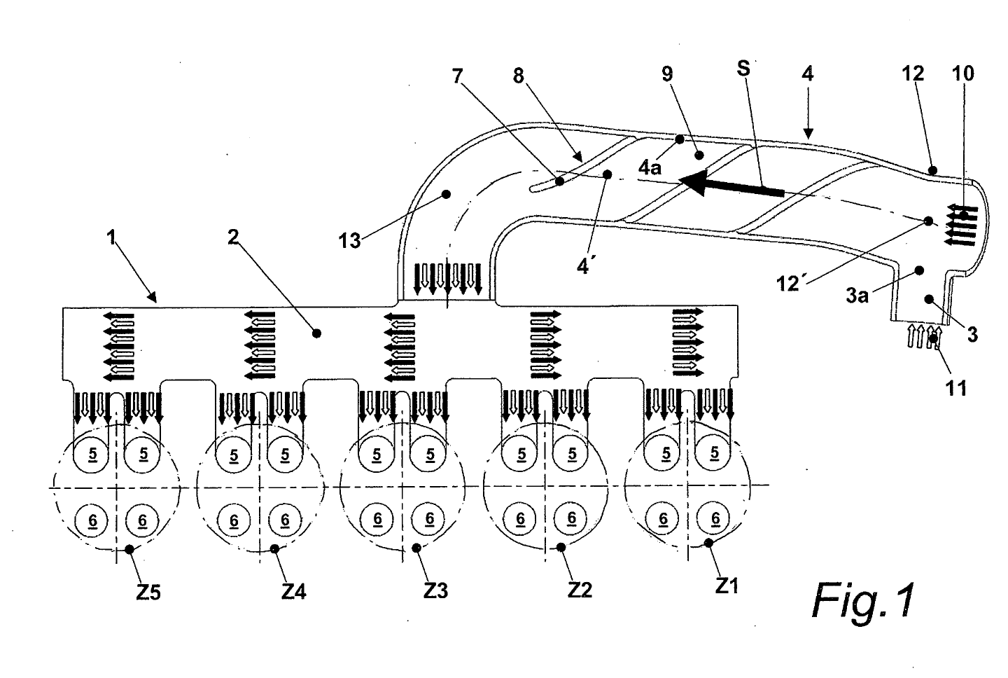

FIG. 1 shows an internal combustion engine in accordance with the invention;

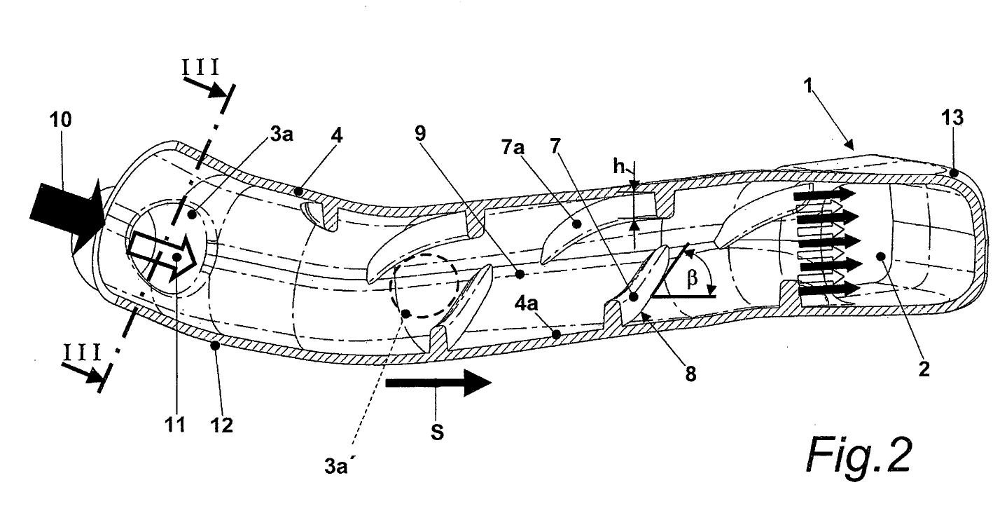

FIG. 2 shows an intake line of this internal combustion engine in a longitudinal sectional view;

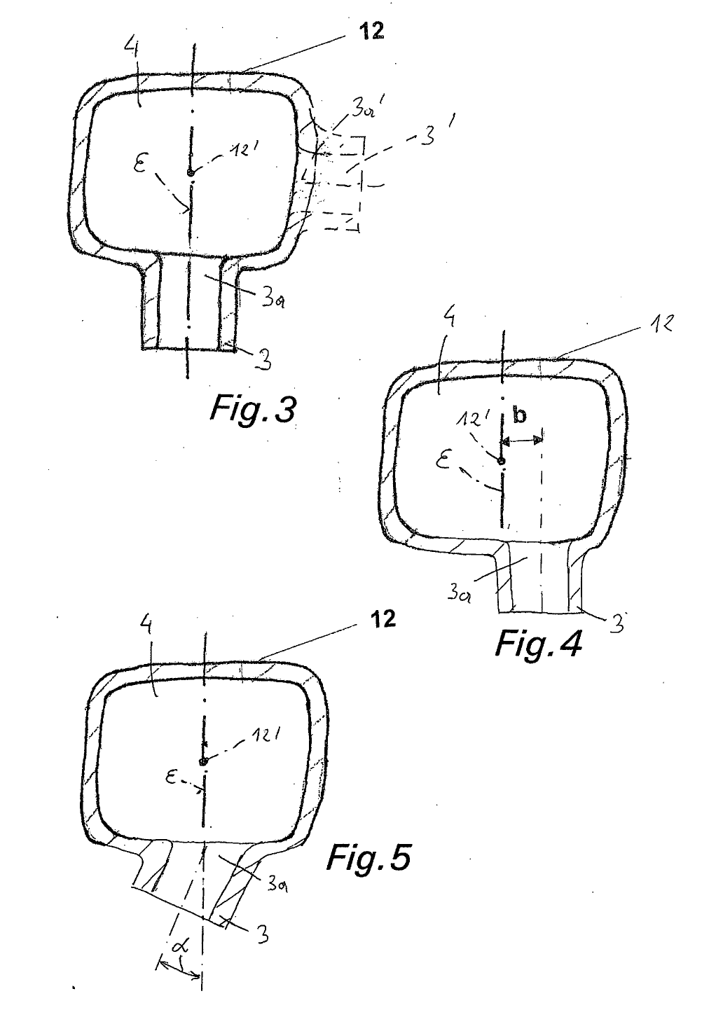

FIG. 3 shows the intake line in a sectional view along line III-III in FIG. 2 in a first embodiment;

FIG. 4 shows the intake line in a sectional view along line III-III in FIG. 2 in a second embodiment, and

FIG. 5 shows the intake line in a sectional view along line III-III in FIG. 2 in a third embodiment.

FIG. 1 shows an internal combustion engine 1 with an intake system 2 and an exhaust system which is not shown in closer detail and which is connected with an intake line 4 via at least one exhaust gas recirculation line 3. The cylinders of the internal combustion engine 1 are designated with Z1, Z2, Z3, Z4, Z5. In the embodiment, each cylinder Z1 to Z5 comprises two intake openings 5 which communicate with the intake system and two exhaust openings 6 which are connected with the exhaust system.

The intake line 4, which is arranged in a curved manner, comprises a mixing section 9 between a bend 12 and an intake manifold 13, which mixing section is arranged in an approximately straight way in the embodiment.

Several swirl elements 8 which are formed by approximately spiral guide ribs 7 are provided in the intake line 4 downstream of the opening 3a of the exhaust gas recirculation line 3 in the wall 4a of the intake line 4. In the embodiment, three spiral guide ribs 7 are provided at the same distance from one another in the intake line 4. As a result of the guide ribs 7 which form screw surfaces 7a in the straight mixing section 9 of the intake line 4, a high swirl or additional turbulence is produced in the direction of flow S. This produces an optimal thorough mixing between the fresh air 10 and the recirculated exhaust gas 11 in a straight mixing section 9 and the downstream intake manifold 13, thus achieving an even distribution of the exhaust gas among the individual cylinders Z1, Z2, Z3, Z4, Z5. There are only slight pressure losses as a result of the additional swirling on the guide ribs 7.

When the swirl elements 8 are arranged in a curved section of the intake line 4, the guide ribs 7 can be provided with different heights h and helix angles 13 in order to compensate disadvantageous effects as a result of the curvature.

Since the components of fresh air and exhaust gas will stratify according to their densities, thorough mixing can be promoted in a purposeful manner in such a way that an inverse distribution is pre-initialized. In an embodiment in the region of bend 12, the exhaust gas recirculation line 3 will therefore open under an angle α of up to 60° into the intake line 4 with reference to the central plane E of the same (FIG. 5). The center of the opening 3a can be arranged in an offset manner by a distance b in relation to the central plane E which is opened up by the axis 12′ of bend 12 (FIG. 4). The distance b is approximately up to 30% of the hydraulic diameter dₕ=4A/U, with A designating the flow cross section and U the wetted circumference of the intake line 4 in the region of the opening 3a.

In order to achieve an especially thorough mixture, at least one separate opening 3a, 3′ of an exhaust gas recirculation line 3, 3′ can be provided per screw thread, as indicated in FIGS. 2 and 3 by the broken lines. The openings 3a, 3a′ can be offset in the direction of the longitudinal axis 4′ of the intake line 4 (FIG. 2) or be arranged offset in the circumferential direction on the intake line 4 (FIG. 3) in a normal plane to the longitudinal axis 4′.

1. An internal combustion engine comprising an intake system and an exhaust system, with the exhaust system being connected to the intake system via at least one exhaust gas recirculation line ending in an intake line, and with at least one swirl element being disposed within the intake line, wherein the swirl element is arranged in the region of a wall of the intake line.

2. The internal combustion engine according to claim 1, wherein the swirl element is formed by a guide rib.

3. The internal combustion engine according to claim 2, wherein the guide rib is interrupted at least once.

4. The internal combustion engine according to claim 1, wherein the swirl element is arranged as a multi-thread screw surface.

5. The internal combustion engine according to claim 4, including at least one opening of an exhaust gas recirculation line per screw thread of the screw surface.

6. The internal combustion engine according to claim 5, wherein the openings are arranged in an offset manner with respect to one another in the circumferential direction.

7. The internal combustion engine according to claim 5, wherein the openings are spaced from one another in a direction of flow.

8. The internal combustion engine according to claim 5, wherein the swirl element is arranged in the intake line downstream of the opening of the exhaust gas recirculation line.

9. The internal combustion engine according to claim 8, wherein the swirl element is arranged in the intake line downstream of the opening which is the first one in the direction of flow.

10. The internal combustion engine according to claim 1, wherein the swirl element is arranged in a straight section of the intake line.

11. The internal combustion engine according to claim 1, wherein the swirl element is arranged in a section of the intake line which is curved at least once.

12. The internal combustion engine according to claim 1, wherein several swirl elements which are axially spaced from one another are arranged in the intake line.

13. The internal combustion engine according to claim 1, wherein the exhaust gas recirculation line opens transversally at a right angle into the intake line.

14. The internal combustion engine according to claim 1, wherein the exhaust gas recirculation line opens transversally into the intake line at an angle less than or equal to 60° with respect to a central plane opened up by the axis of a bend.

15. The internal combustion engine according to claim 15, wherein the opening of the exhaust gas recirculation line is arranged in an offset manner in the region of the bend laterally by a defined amount which can be up to 30% of the hydraulic diameter of the intake line with reference to a central plane opened up by the axis of the bend.

16. The internal combustion engine according to claim 1, wherein the swirl element is arranged integrally with the intake line.

17. The internal combustion engine according to claim 12, wherein the swirl elements have locally different heights and/or helix angles.
